(19) United States
(12) Patent Application Publication
(10) Pub. No.: US 2007/0266939 A1
(43) Pub. Date: Nov. 22, 2007

(54) Powder Coating System

(76) Inventors: Mitsuyoshi Kumata, Tokyo (JP); Akira Nakamura, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/579,910

(22) PCT Filed: Nov. 18, 2004
(86) PCT No.: PCT/JP04/17156

§ 371 Date: May 19, 2006

(30) Foreign Application Priority Data
Nov. 20, 2003 (JP) 2003-390770

(51) Int. Cl. B05B 15/12

(52) U.S. Cl. 118/621

(57) ABSTRACT

First divided booths 2 and 3 are moved to coating positions 2 to form a coating booth and an article to be coated carried by a carrying device is coated in the coating booth. Second divided booths 5 and 6 are retracted to cleaning positions C and cleaning booths 8 and 9 are moved from retracted positions T to operating positions S5 and S6 to cover the openings of the divided booths 5 and 6, and then cleaning is performed in this state. After the cleaning is completed, the cleaning booths 8 and 9 are returned to the retracted positions T, and the second divided booths 5 and 6 are moved to the coating positions P to form a second coating booth. After the coating by the first divided booths 2 and 3 is completed, the first divided booths 2 and 3 are retracted from the coating positions e to the cleaning positions C, the cleaning booths 8 and 9 are moved from the retracted positions T to the operating positions S2 and S3, and the cleaning is performed to ready for a next color change.

### TECHNICAL FIELD

The present invention relates to a powder coating system, and more particularly, to a coating system suitable for color change.

### BACKGROUND ART

In recent years, from the view point of environmental protection, electrostatic powder coating using powder coating material is attracting attention as a pollution-free coating method using no solvent and friendly to the environment. In electrostatic powder coating, powder coating material ejected with carrier airflow from a nozzle opening formed at the forward end of a coating gun adheres to a surface of an article to be coated.

Here, to prevent the coating material from being scattered around during coating, a method is available in which, as disclosed, for example, in Patent Document 1, an article to be coated, which is carried by a carrying device while suspended therefrom, is introduced into a booth, where powder coating material is blown against the article to be coated.

[Patent Document] JP 08-266944 A

### DISCLOSURE OF THE INVENTION

### PROBLEMS TO BE SOLVED BY THE INVENTION

However, when coating is performed in this way, the powder coating material adheres to an inner wall surface and a floor surface of the booth. Thus, when effecting color change in coating, the carrying of the article to be coated is stopped, and while sucking the air inside the booth by a dust collector, compressed air is blown against the inner wall surface and the floor surface of the booth by an air gun or the like to remove the adhering powder coating material, and then coating is performed using new powder coating material of a different color. In particular, in powder coating, a method is often adopted in which the powder coating material that has not adhered to the article to be coated although blown against the same is recovered to be elected from the coating gun again. Thus, elaborate cleaning is required at the time of color change so that powder coating materials of different colors will not be mixed with each other.

When an interior of the booth is thus cleaned after stopping the carrying of the article to be coated each time color change is to be effected, the efficiency of the coating process deteriorates markedly. In view of this, there has been conceived a method in which a plurality of movable booths are arranged in series along a carrying device so as to be capable of being retracted from the carrying device and in which coating is conducted in one booth while the other booth is retracted to clean the interior of the booth.

However, the booths are formed so as to surround from both sides the article to be coated suspended from the carrying device, so when the article to be coated is suspended, the booths cannot be retracted. Thus, it is necessary to provide the carrying device with a blank portion in which no article to be coated is suspended and which is long enough to allow retraction of the booths, resulting in a deterioration in the efficiency of the coating process.

The present invention has been made with a view toward solving the above problem in the prior art. It is an object of the present invention to provide a powder coating system which allows efficient color change.

### MEANS FOR SOLVING THE PROBLEMS

According to the present invention, a powder coating system for coating an article to be coated, which is carried along a carrying path and is placed within a coating booth, includes: a pair of divided booths arranged on both sides of the carrying path so that each of the pair of divided booths is movable between a coating position close to the carrying path and a cleaning position retracted from the carrying path, and whose respective sides opposed to the carrying path nave openings, with the openings being close to each other when at the coating positions to form a coating booth surrounding the article to be coated; and closing means for covering the openings of the divided booths retracted to the cleaning positions, in which an interior of each of the divided booths is cleaned, with the opening of the divided booth at the cleaning position being covered with the closing means.

Note that, if the plurality of pairs of divided booths are arranged in series along the carrying path, efficient coating can be performed.

The closing means may be composed of a pair of cleaning booths arranged so that each of the pair of cleaning booths is movable between an operating position where each of the pair of cleaning booths covers the opening of the divided booth retracted to the cleaning position and a retracted position where each of the pair of cleaning booths does not interfere with movement paths for the divided booths. In this case, the pair of cleaning booths may be integrated with each other. A common cleaning booth may be arranged for a plurality of divided booths. While coating is being performed by other divided booths forming a coating booth, the pair of divided booths may be moved to the cleaning positions, and at the same time, the cleaning booths may be moved to the operating positions to clean the divided booths.

It is also possible to realize a construction in which most of the openings of the divided booths are covered with the closing means while leaving opening slits, and air inside the divided booths are sucked, whereby outside air is taken into the divided booths from the opening slits to remove powder coating material adhering to inner wall surfaces of the divided booths.

It is desirable to connect a cyclone to the coating booths to recover the powder coating material that has failed to adhere to the surface of the article to be coated. In this case, cyclones may be connected to a pair of divided booths, respectively, or one cyclone may be connected to a pair of divided booths.

Further, it is also possible to mount a blowoff device to each divided booth and to blow compressed air against the inner wall surface and the floor surface of the divided booth to thereby remove powder coating material therefrom.

It is possible to perform coating on an article to be coated by a coating gun mounted on a reciprocator. In this case, it is also possible to blow compressed air against the outer surface of the coating gun by a blowoff device to thereby remove powder coating material therefrom.

### EFFECTS OF THE INVENTION

In accordance with the present invention, there is formed a coating booth surrounding an article to be coated by a pair of divided booths arranged on either side of a carrying path so as to be movable between coating positions close to the carrying path and cleaning positions retracted from the carrying path, and the interior of the divided booths are cleaned, with openings of the divided booths retracted to the cleaning positions being closed by closing means, so it is possible to perform retracting the divided booths and cleaning on the retracted booths without having to provide a blank portion where no article to be coated is suspended, there by making it possible to achieve an improvement in terms of the efficiency of the coating process.

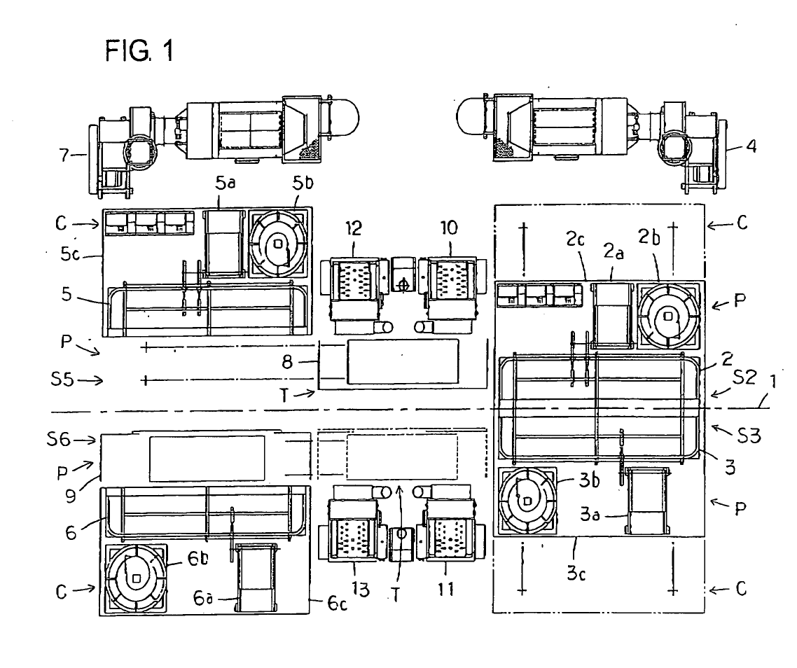

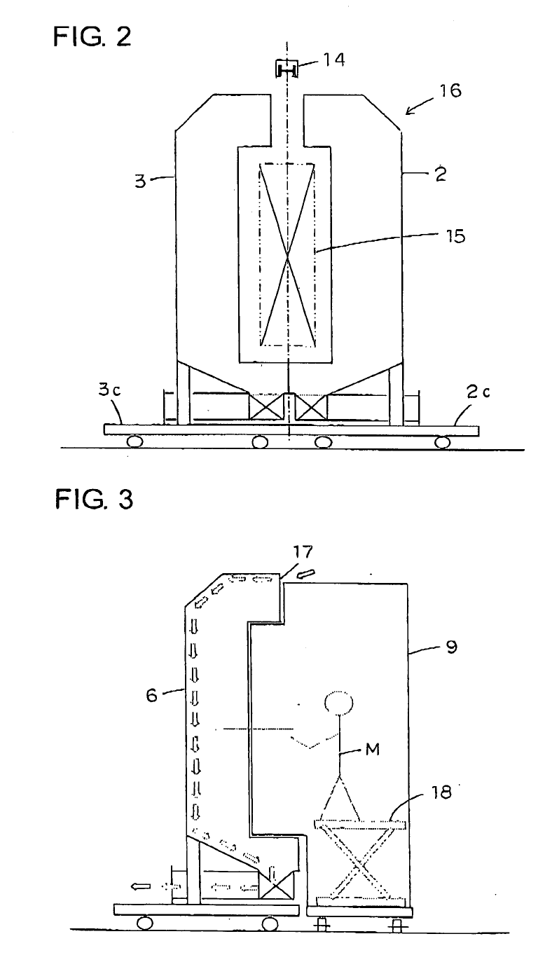

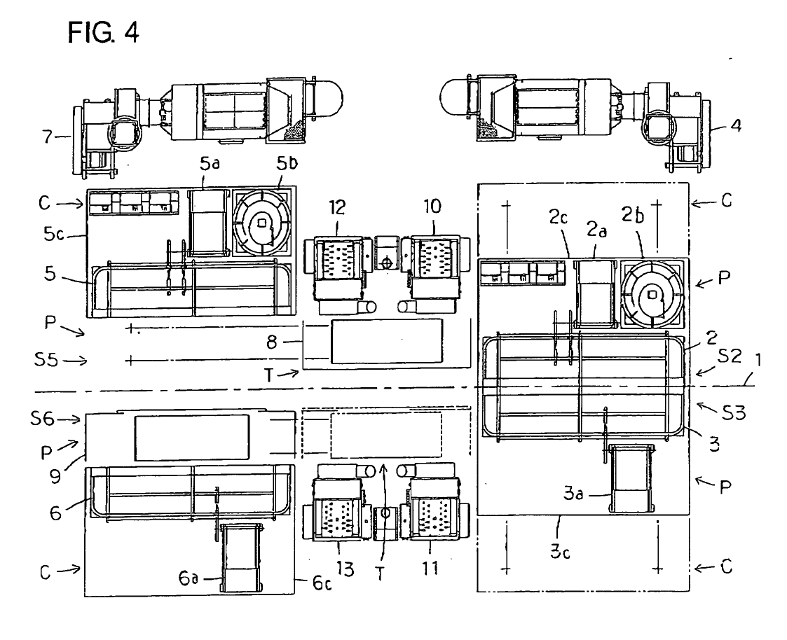

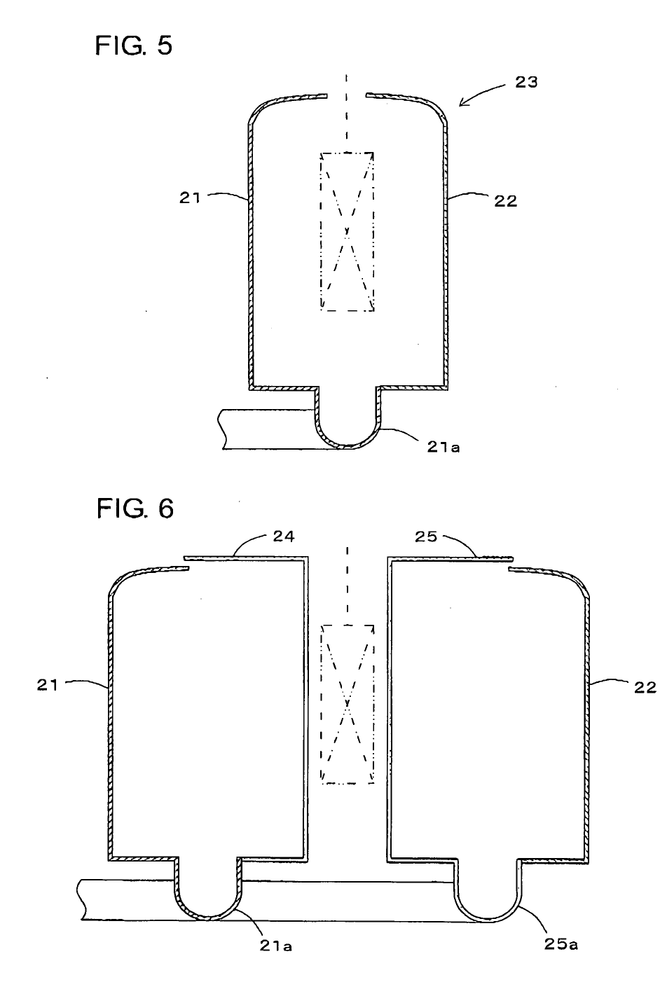

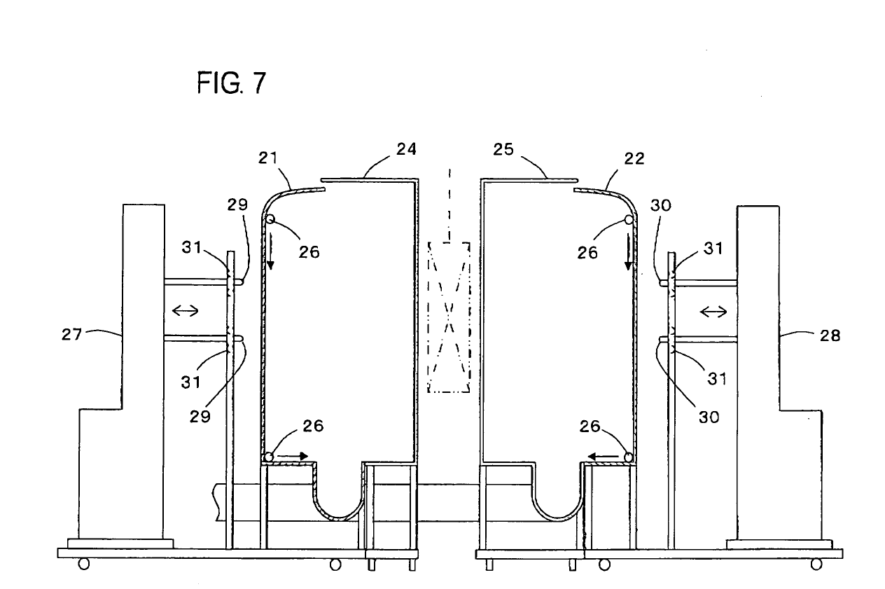

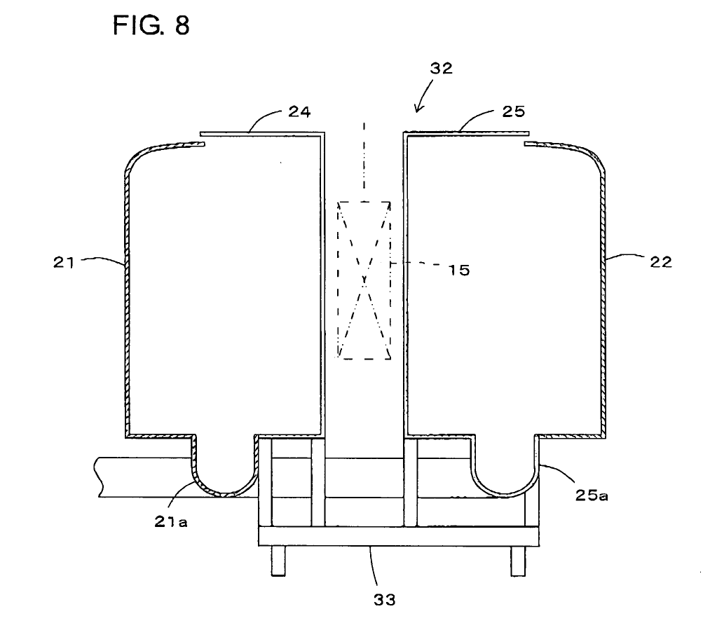

### BRIEF DESCRIPTION OF THE DRAWINGS

[FIG. 1] FIG. 1 is a plan view showing a general construction of a powder coating system according to Embodiment 1 of the present invention.

[FIG. 2] FIG. 2 is a front view showing a pair of divided booths in a state in which they have been moved to coating positions to form a coating booth in Embodiment 1.

[FIG. 3] FIG. 3 is a front view showing a divided booth in a state in which it has been moved to a cleaning position to be cleaned by a cleaning booth in Embodiment 1.

[FIG. 4] FIG. 4 is a plan view showing a general construction of a powder coating system according to Embodiment 2 of the present invention.

[FIG. 5] FIG. 5 is a front sectional view showing a pair of divided booths in a state in which they have been moved to coating positions to form a coating booth in Embodiment 2.

[FIG. 6] FIG. 6 is a front sectional view showing a divided booth in a state in which it has been moved to a cleaning position to be cleaned by a cleaning booth in Embodiment 2.

[FIG. 7] FIG. 7 is a front sectional view of a powder coating system according to Embodiment 3 in a cleaning state.

[FIG. 8] FIG. 8 is a front sectional view of a cleaning booth used in a powder coating system according to Embodiment 4.

### BEST MODE FOR CARRYING OUT THE INVENTION

In the following, embodiments of the present invention will be described with reference to the accompanying drawings.

### Embodiment 1

FIG. 1 shows a general construction of a powder coating system according to Embodiment 1. There is formed a carrying path 1 for carrying an article to be coated by a carrying device (not shown). On either side of the carrying path 1, a pair of first divided booths 2 and 3 are arranged so as to sandwich the carrying path 1. The divided booth 2 is installed on a movable stage 2c together with a reciprocator 2a, to which a coating gun is mounted, and a cyclone 2b, which serves to recover powder coating material that has been blown against the article to be coated but has failed to adhere to a surface of the article to be coated and to eject the powder coating material from the coating gun again. Similarly, the divided booth 3 is installed on a movable stage 3c together with a reciprocator 3a and a cyclone 3b. The divided booths 2 and 3 are arranged so as to be capable of being moved respectively by the movable stages 2c and 3c between coating positions P close to the carrying path 1 and cleaning positions C retracted from the carrying path 1.

In the vicinity of the divided booth 2, there is arranged a first bag filter 4, which is connected by piping (not shown) to the cyclones 2b and 3b when the divided booths 2 and 3 are placed at the coating positions P, and to the interior of the divided booths 2 and 3 when they are placed at the cleaning positions C.

On either side of the carrying path 1, a pair of second divided booths 5 and 6 are arranged so as to sandwich the carrying path 1 while being spaced apart from the first divided booths 2 and 3 along the carrying path 1. The divided booth 5 is installed on a movable stage 5c together with a reciprocator 5a and a cyclone 5b. The divided booth 6 is installed on a movable stage 6c together with a reciprocator 6a and a cyclone 6b. The divided booths 5 and 6 are arranged so as to be capable of being moved respectively by the movable stages 5c and 6c between coating positions P close to the carrying path 1 and cleaning positions C retracted from the carrying path 1.

In the vicinity of the divided booth 5, there is arranged a second bag filter 7, which is connected by piping (not shown) to the cyclones 5b and 6b when the divided booths 5 and 6 are placed at the coating positions P, and to the interior of the divided booths 5 and 6 when they are placed at the cleaning positions C.

On one side of the carrying path 1, a cleaning booth 8 is arranged between the divided booth 2 and the divided booth 5, and, on the other side of the carrying path 1, a cleaning booth 9 is arranged between the divided booth 3 and the divided booth 6. The cleaning booth 8 is arranged so as to be capable of moving, parallel to the carrying path 1, from an operating position S2 corresponding to the coating position P for the divided booth 2 to an operating position S5 corresponding to the coating position P for the divided booth 5 by way of a retracted position T between the divided booth 2 and the divided booth 5. Similarly, the cleaning booth 9 is arranged so as to be capable of moving, parallel to the carrying path 1, from an operating position S3 corresponding to the coating position P for the divided booth 3 to an operating position S6 corresponding to the coating position P for the divided booth 6 by way of a retracted position T between the divided booth 3 and the divided booth 6.

The respective surfaces of the divided booths 2 and 3 facing the carrying path 1 are open. When the divided booths are placed at the coating positions P, their respective openings are brought close to each ocher to define a coating booth surrounding the article to be coated.

The retracted position T for the cleaning booth 8 is set at a position where the cleaning booth 8 does not interfere with the moving path for the divided booths 2 and 5. Similarly, the retracted position T for the cleaning booth 9 is set at a position where the cleaning booth 9 does not interfere with the moving path for the divided booths 3 and 6.

Further, in the vicinity of the divided booths 2, 3, 5 and 6, there are arranged coating material supply devices 10, 11, 12 and 13 for supplying powder coating materials of a plurality of colors to coating guns.

The inner wall surfaces of the divided booths 2, 3, 5 and 6 are formed of metal or resin or the like to which powder coating material does not easily adhere.

Next, the operation of Embodiment 1 will be described.

As shown in FIG. 1, the first divided booths 2 and 3 are moved to their respective coating positions P by the movable stages 2c and 3c At this time, as shown in FIG. 2, a coating booth 16, which surrounds an article to be coated 15 suspended from a carrying device 14 through the intermediation of a hanger, is formed by the first divided booths 2 and 3.

In this state, a plurality of articles to be coated 15 are suspended at predetermined intervals from the carrying device 14 and are carried at a predetermined carrying speed. At the same time, powder coating material 15 supplied from the coating material supply devices 10 and 11 to the coating guns of the reciprocators 2a and 3a, and the powder coating material is blown against the article to be coated 15 introduced into the coating booth 16. The divided booths 2 and 3 have been moved to the coating positions P, so the first bag filter 4 is connected to the cyclones 2b and 3b by piping (not shown). Here, when the first bag filter 4 is driven, in the coating booth 16, the powder coating material that has been blown against the article to be coated 15 but has failed to adhere to the surface of the article to be coated 15 is recovered by the cyclones 2b and 3b and is returned to the coating material supply devices 10 and 11 to be ejected from the coating guns again. Fine particles that are not recovered by the cyclones 2b and 3b are captured by the first bag filter 4.

In this way, coating is performed successively on a plurality of articles to be coated 15.

At this time, as shown in FIG. 1, the second divided booths 5 and 6 are retracted to their respective cleaning positions C from the coating positions P, and the cleaning booths 8 and 9 are moved from their respective retracted positions T to their respective operating positions S5 and S6. As a result, as shown in FIG. 3, most of the opening of the divided booth 6 is covered with the cleaning booth 9. It should be noted, however, the cleaning booth 9 is formed so as to be somewhat lower than the divided booth 6, so that a narrow opening slit 17 is formed at an upper end of the divided booth 6. Further, the divided booth 6 has been moved to the cleaning position C, so the second bag filter 7 is connected to the interior of the divided booth 6 through piping (not shown).

In this state, the second bag filter 7 is driven to suck the air in the divided booth 6. Then, as indicated by arrows of FIG. 3, outside air is taken in from the opening slit 17 at the upper end, and flows along an inner wall surface of the divided booth 6. As a result, the powder coating material allowed to adhere to the inner wall surface of the divided booth 6 on the occasion of the previous coating is efficiently removed, and is captured by the second bag filter 7. Installed in the cleaning booth 9 is a lifter 18 for the operator M to mount. It is also possible for the operator M to enter the cleaning booth 9 as needed, and remove powder coating material by blowing compressed air against the inner wall of the divided booth 6 by an air gun or the like.

Similarly, the opening of the divided booth 5 is substantially covered with the cleaning booth 8, and the interior of the divided booth 5 is cleaned by driving the second bag filter 7.

When the cleaning of the second divided booths 5 and 6 is thus completed, the cleaning booths 8 and 9 are restored to their respective retracted positions T, and the second divided booths 5 and 6 are moved to their respective coating positions P to form the second coating booth. At the time of the next color change, powder coating material of a new color is supplied to the coating guns of the reciprocators 5a and 6a, whereby it is possible to start coating immediately.

When the coating using the first divided booths 2 and 3 is completed, the first divided booths 2 and 3 are retracted from their respective coating positions P to their respective cleaning positions C, and the cleaning booths 8 and 9 are moved from their respective retracted positions T to their respective operating positions S2 and S3, and cleaning is performed for the next color change.

As described above, the divided booths 2, 3, 5 and 6 are arranged so as to be movable between their respective coating positions P close to the carrying path 1 and their respective cleaning positions C retracted from the carrying path 1. Thus, if the articles to be coated 15 to be coated are successively carried by the carrying device 14, the divided booths can be moved between their respective coating positions 2 and their respective cleaning positions C, and it is possible to perform cleaning on the divided booths retracted to the cleaning positions C while covering the openings of the divided booths, so it is possible to effect color change efficiently, thereby markedly improving the efficiency of the coating process.

While in Embodiment 1 described above there are arranged the cleaning booths 8 and 9 common to the first divided booths 2 and 3 and the second divided booths 5 and 6, it is also possible to arrange dedicated cleaning booths for each group of divided booths.

Instead of the cleaning booths 8 and 9, it is also possible to use shutters, plate-like members, etc. as closing means to cover the openings of the divided booths 2, 3, 5 and 6. In this case also, it is desirable to cover most of the openings of the divided booths with the closing means while leaving opening slits, and to take in outside air into the divided booths through the opening slits through suction of the air inside the divided booths to thereby remove the powder coating material adhering to the inner wall surfaces of the divided booths.

### Embodiment 2

FIG. 4 snows a general construction of a powder coating system according to Embodiment 2. While in the powder coating system of Embodiment 1 shown in FIG. 1 the cyclones 2b, 3b, 5b and 6b are arranged for the divided booths 2, 3, 5 and 6, respectively, in Embodiment 2, one cyclone is connected to a pair of divided booths to be brought close to each other to form a coating booth. As shown in FIG. 4, one cyclone 2b is arranged on the movable stage 2c for the first divided booths 2 and 3, and is connected to the first divided booths 2 and 3 and the first bag filter 4. Similarly, one cyclone 5b is arranged on the movable stage 5c for the second divided booths 5 and 6, and is connected to the second divided booths 5 and 6 and the second bag filter 7.

In this construction also, by driving the first bag filter 4, the powder coating material that has failed to adhere to the surface of the article to be coated is recovered by the cyclone 2b, and is restored to the coating material supply devices 10 and 11 to be blown from the coating gun again. Similarly, by driving the second bag filter 7, the powder coating material that has failed to adhere to the surface of the article to be coated is recovered by the cyclone 5b, and is restored to the coating material supply devices 12 and 13 to be blown from the coating gun again.

In Embodiment 2, one cyclone is arranged for a pair of divided booths to recover powder coating material, whereby it is possible to achieve a reduction in equipment cost.

To be more specific, as shown, for example, in FIG. 5, a pair of divided booths are arranged asymmetrically, and are composed of a divided booth 21 having an exhaust duct 21a at the bottom and a divided booth 22 having no exhaust duct, with a cyclone (not shown) being connected to the exhaust duct 21a of the divided booth 21. When the divided booths 21 and 22 are brought close to each other to form a coating booth 23, air is taken in through the exhaust duct 21a of the divided booth 21 to recover powder coating material.

As stolen in FIG. 6, in correspondence with the asymmetrical divided booths 21 and 22, cleaning booths 24 and 25 are also arranged asymmetrically, and the cleaning booth 24 corresponding to the divided booth 21 with the exhaust duct 21a has no exhaust duct, whereas the cleaning booth 25 corresponding to the divided booth 22 with no exhaust duct has an exhaust duct 25a. With this construction, at the time of cleaning, it is possible to take in air through the exhaust duct 21a of the divided booth 21 and through the exhaust duct 25a of the cleaning booth 25.

### Embodiment 3

FIG. 7 shows a powder coating system according to Embodiment 3. According to Embodiment 3, in the powder coating system of Embodiment 2 described above, a blowoff device 26 is mounted to each of the divided booths 21 and 22 to blow compressed air against the inner wall surfaces and the floor surfaces of the divided booths 21 and 22, thereby removing powder coating material adhering thereto. Further, blowoff devices 31 are installed respectively in the vicinity of coating guns 29 and 30 mounted to reciprocators 27 and 28 to blow compressed air against the outer surfaces of coating guns 29 and 30, thereby removing powder coating material adhering thereto.

By blowing compressed air from the blowoff devices 26 and 31, the inner wall surfaces and the floor surfaces of the divided booths 21 and 22 and the outer surfaces of the coating guns 29 and 30 are cleaned, making it possible to effect color change efficiently.

Similarly, the powder coating system of Embodiment 1 may also be provided with blowoff devices to clean the inner wall surfaces and the floor surfaces of the divided booths 2, 3, 5 and 6 and the outer surface of the coating gun.

### Embodiment 4

FIG. 8 shows a cleaning booth 32 for use in a powder coating system according to Embodiment 4. The cleaning booth 32 is formed by fixing the pair of cleaning booths 24 and 25 of Embodiment 2 shown in FIG. 6 to a common movable base 33 and integrating them with each other. The movable base 33 is movable, parallel to the carrying path for the article to be coated 15, between an operating position where the openings of the divided booths 21 and 22 are covered as shown in FIG. 8 and a retracted position where the movable base 33 does not interfere with the movement paths for the divided booths 21 and 22. Between the pair of cleaning booths 24 and 25 integrated with each other through the intermediation of the movable base 33, there is formed a gap large enough to allow passage of the article to be coated 15, so it is possible to carry the article to be coated 15 even when the divided booths 21 and 22 are being cleaned, and there is no fear of powder coating material scattered during cleaning adhering to the article to be coated 15.

By thus integrating the pair of cleaning booths 24 and 25 with each other, a single movement device suffices for the movement of the cleaning booth between the operating position and the retracted position, thereby simplifying the construction and achieving a reduction in equipment cost.

Similarly, it is also possible to integrate with each other the pair of cleaning booths 8 and 9 of Embodiment 1.

While in Embodiments 1 and 2 two pairs of divided booths are arranged, this should not be construed restrictively. It is also possible to arrange three pairs or more of divided booths.

Further, while the present invention relates to a powder coating system using powder coating material, it is also possible to combine the powder coating system of the present invention with an existing solvent coating line using a solvent type coating material to form a coating line for both solvent coating and powder coating. The divided booths are retracted to cleaning positions to clean the interior of the divided booths, so there is no need to stop the line even at the time of cleaning of the divided booths, and it is also possible to perform solvent coating at this time. Thus, it is possible to construct a system superior in coating efficiency that can be used for both solvent coating and powder coating.

1. A powder coating system for coating an article to be coated, which is carried along a carrying path and is placed within a coating booth, comprising:
a pair of divided booths arranged on both sides of the carrying path to be each movable between a coating position close to the carrying path and a cleaning position retracted from the carrying path, respective sides of the divided booths opposed to the carrying path having openings which are close to each other when at the coating positions to form a coating booth surrounding the article to be coated; and
closing means for covering the openings of the divided booths retracted to the cleaning positions,
wherein an interior of each of the divided booths is cleaned with the opening of the divided booth at the cleaning position being covered with the closing means.

2. A powder coating system according to claim 1 wherein the plurality of pairs of divided booths are arranged in series along the carrying path.

3. A powder coating system according to claim 1 wherein the closing means comprises a pair of cleaning booths arranged to be each movable between an operating position where each of the pair of cleaning booths covers the opening of the divided booth retracted to the cleaning position and a retracted position where each of the pair of cleaning booths does not interfere with movement paths for the divided booths.

4. A powder coating system according to claim 3 wherein the pair of cleaning booths are integrated with each other.

5. A powder coating system according to claim 3 wherein a common cleaning booth is arranged for a plurality of divided booths

6. A powder coating system according to claim 3 wherein awhile coating is being performed by a first pair of divided booths forming a coating booth, a second pair of divided booths are moved to the cleaning positions, and at the same time, the cleaning booths are moved to the operating positions to clean the second pair of divided booths.

7. A powder coating system according to claim 1 wherein most of the openings of the divided booths are covered with the closing means while leaving opening slits, and air inside the divided booths are sucked so that outside air is taken into the divided booths from the opening slits to remove powder coating material adhering to inner wall surfaces of the divided booths.

8. A powder coating system according to claim 1 wherein a cyclone is connected to the coating booth.

9. A powder coating system according to claim 8 wherein the one cyclone is connected to a pair of divided booths.

10. A powder coating system according to claim 1 wherein each of the divided booths is equipped with a blowoff device for blowing compressed air against the inner wall surface and a floor surface of the divided booth to remove powder coating material therefrom.

11. A powder coating system according to claim 1 further comprising a reciprocator to which a coating gun for performing coating on the article to be coated placed within the coating booth is mounted.

12. A powder coating system according to claim 11 further comprising a blowoff device for blowing compressed air against an outer surface of the coating gun to remove powder coating material from the outer surface of the coating gun.
